(19) United States
(12) Patent Application Publication
(10) Pub. No.: US 2013/0096849 A1
(43) Pub. Date: Apr. 18, 2013

(54) Force Sensitive Interface Device and Methods of Using Same

(71) Applicant: NextInput Inc., Atlanta, CA (US)

(72) Inventors: Ian Campbell, Smyrna, GA (US); Ryan Diestelhorst, Atlanta, GA (US)

(73) Assignee: NEXTINPUT INC., Atlanta, GA (US)

(21) Appl. No.: 13/649,526

(22) Filed: Oct. 11, 2012

Related U.S. Application Data
(60) Provisional application No. 61/547,673, filed on Oct. 14, 2011.
(60) Provisional application No. 61/569,603, filed on Dec. 12, 2011.
(60) Provisional application No. 61/581,543, filed on Dec. 29, 2011.

(51) Int. Cl. G06F 19/00

(52) U.S. Cl. 702/42; 702/41

(57) ABSTRACT

An interface device for measuring forces applied to the interface device. The interface device has a flexible contact surface suspended above a rigid substrate. The interface device has at least one sensor in communication with the contact surface. The interface device has processing circuitry for receiving signals from the sensors and substantially instantaneously producing an output signal corresponding to the location and force applied in multiple locations across the contact surface.

### CROSS-REFERENCE TO RELATED APPLICATIONS

This application claims the benefit of the filing date of U.S. Provisional Patent Application No. 61/547,673, filed on Oct. 14, 2011, U.S. Provisional Patent Application No. 61/569,603, filed on Dec. 12, 2011, and U.S. Provisional Patent Application No. 61/581,543, filed on Dec. 29, 2011, each of which is incorporated herein by reference in its entirety.

### FIELD

This invention relates to an interface device and, more specifically, to an interface device for measuring an applied force and producing an output signal.

### BACKGROUND

A variety of known interface devices permit interaction between a user and external devices, such as personal computers. These known interface devices, such as conventional computer mouse devices, are moveable by a user to selectively alter the appearance of a display associated with an external device. For example, a conventional computer mouse can be moved to control the two-dimensional position of a cursor graphically depicted on a computer monitor display. Known interface devices also have one or more elements for receiving an action by the user and communicating the action to an external device. For example, a conventional computer mouse has buttons that can be pressed by a user to select an icon or other graphic depicted on a computer monitor display. However, the elements for receiving user actions in most known interface devices are only capable of receiving and recognizing binary actions in which only two user responses are possible, such as “on/off” or “yes/no.” Thus, most known interface devices are incapable of receiving and recognizing non-binary actions in which user responses within a continuous range of options are possible. Moreover, known interface devices are unable to simultaneously and efficiently calculate input in the X and Y axes as well as determine the force profile for multiple touch points at a given time.

Accordingly, there is a need in the pertinent art for an interface device that is capable of receiving and recognizing both touch location and touch force for a multitude of touch points with accurate and efficient calculation methodologies that do not limit the speed and accuracy of the interface to a degree recognizable by the user.

### SUMMARY

In exemplary aspects, the invention pertains to a force sensitive interface device for providing touch input into a data processing system. The device comprises a contact body having a flexible outer surface for receiving external forces from a user with an array of sensors (such as, for example, strain gauges, force sensors, and/or pressure sensors) on its underside or otherwise operatively positioned, each sensing localized force on the surface as a result of the forces acting along the surface, and producing signals proportional to those forces so that the device can detect with a high degree of accuracy the position and magnitudes of external forces acting on the surface of the device. Optionally, the surface can be suspended with spacers attached to a rigid body beneath the surface.

In additional aspects, the invention pertains to a method of providing touch input into a data processing system. The method comprises the steps of sensing the location and magnitude of forces along a surface. The steps include deforming the surface slightly so that the surface deflects from its original or static position slightly, an array of sensors sensing the change in force within the surface and producing a signal that is communicated through interface circuitry to a processor, the processor interpreting the many signals from the force sensors and using a software algorithm to reconstruct a map of the original force distribution along the surface of the device.

In one exemplary aspect, the force-sensitive interface device includes a flexible contact body defining a contact surface, with the contact surface being configured to simultaneously receive a plurality of external forces. The force-sensitive interface device further includes a plurality of sensors operatively associated with the flexible contact body. Each sensor of the plurality of sensors is configured to sense localized forces applied to the contact surface of the flexible contact body and configured to produce a force signal indicative of the external forces sensed by the sensor. The force-sensitive interface device further includes a processor positioned in operative communication with the plurality of sensors, the processor being configured to receive the force signal produced by each respective sensor of the plurality of sensors. The processor is further configured to convert the force signals received from the plurality of sensors into one or more output signals indicative of the intensity and origin position of each respective force of the plurality of external forces.

Optionally, the processor is configured for selective communication with each respective sensor of the plurality of sensors. Upon initiation of communication between the processor and each respective sensor of the plurality of sensors, the sensor is configured to transmit the force signal to the processor.

### DETAILED DESCRIPTION OF THE FIGURES

These and other features of the preferred embodiments of the invention will become more apparent in the detailed description in which reference is made to the appended drawings wherein:

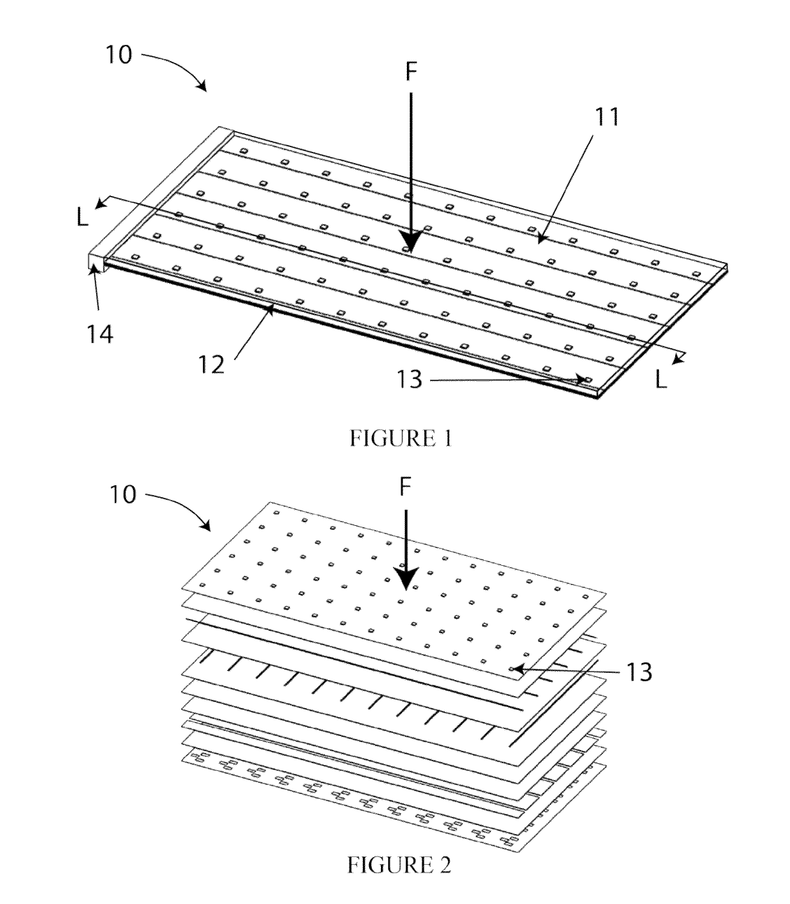

FIG. 1 is an isometric view of the force sensitive device.

FIG. 2 is an exploded perspective of the force sensitive device of FIG. 1.

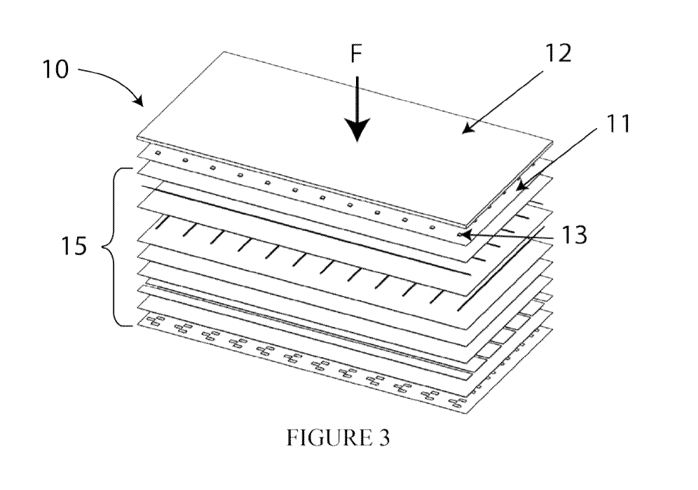

FIG. 3 is an exploded perspective of the force sensitive device with an LCD screen as the touch surface.

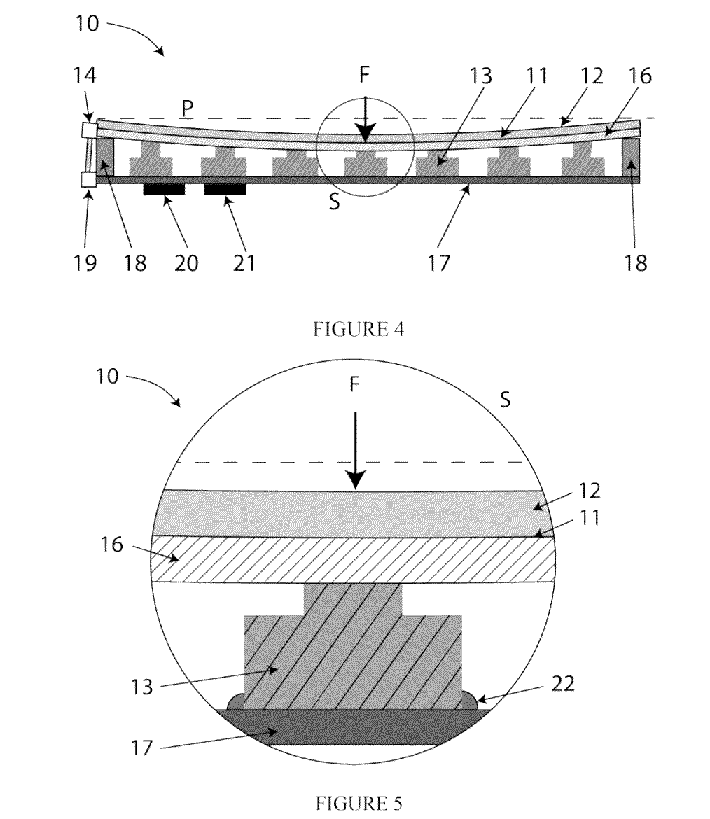

FIG. 4 is a cross sectional view of the force sensitive device using force sensors along the line L of FIG. 1, with a force F applied.

FIG. 5 is a sectional view of the force sensitive device within the section S of FIG. 4, with a force F applied.

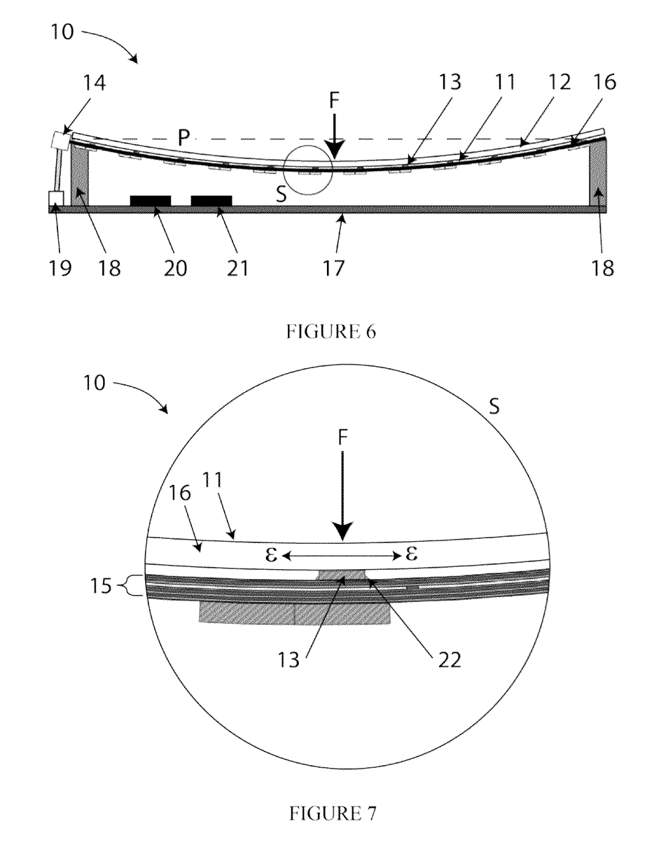

FIG. 6 is a cross sectional view of the force sensitive device using strain sensors along the line L of FIG. 1, with a force F applied.

FIG. 7 is a sectional view of the force sensitive device within the section S of FIG. 6, with a force F applied.

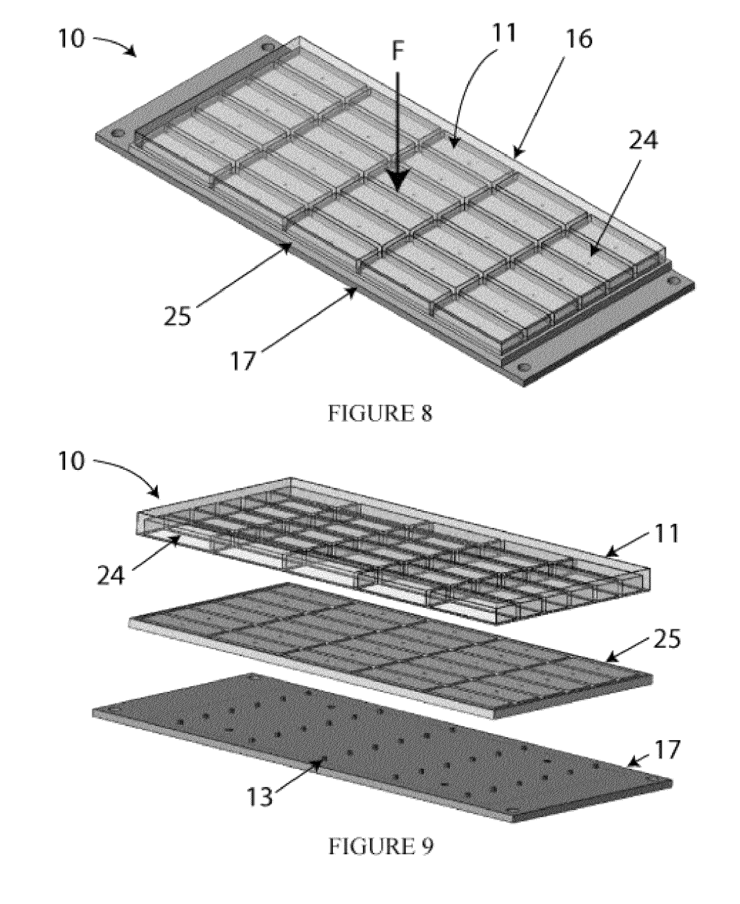

FIG. 8 is an isometric view of the pressure sensitive device.

FIG. 9 is an exploded perspective of the pressure sensitive device of FIG. 8.

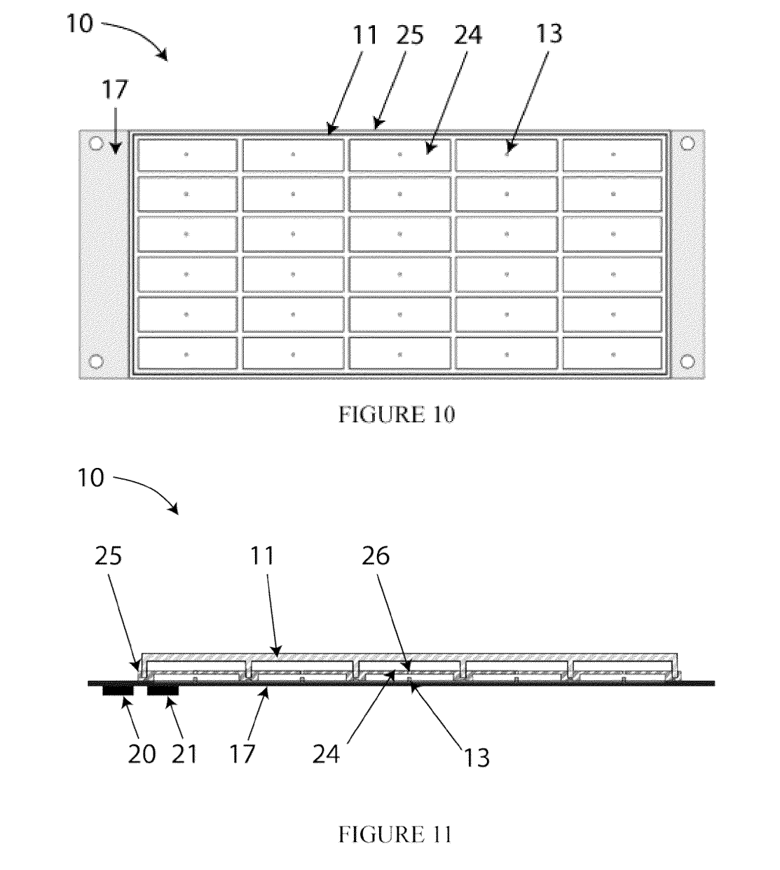

FIG. 10 is a top view of the pressure sensitive device of FIG. 8.

FIG. 11 is a cross sectional view of the pressure sensitive device of FIG. 8.

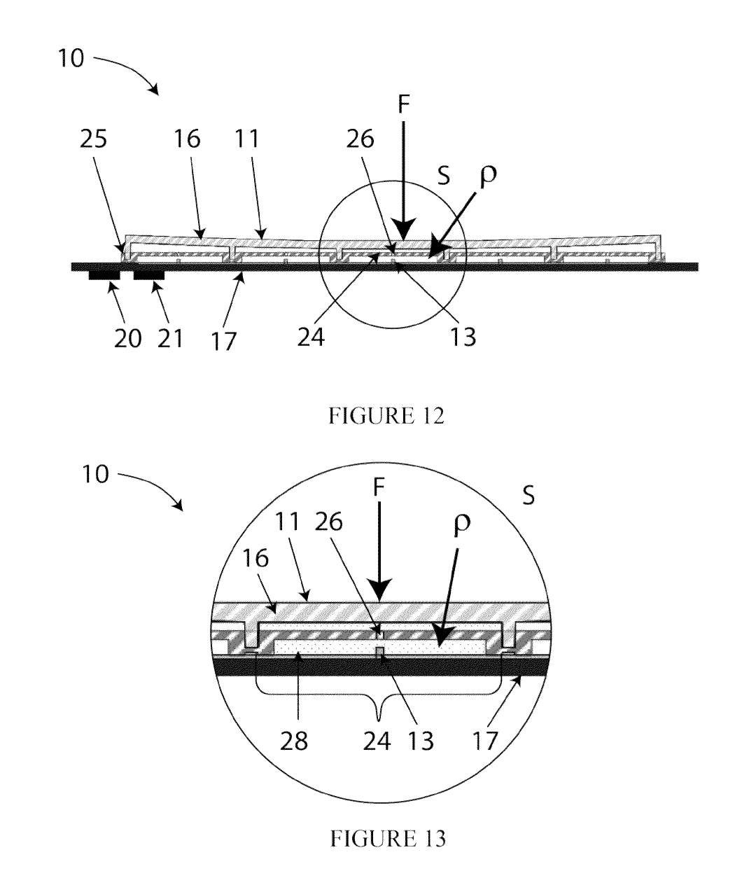

FIG. 12 is a cross sectional view of the pressure sensitive device of FIG. 8 with a force F applied.

FIG. 13 is a sectional view of the pressure sensitive device within the section S of FIG. 12, with a force F applied.

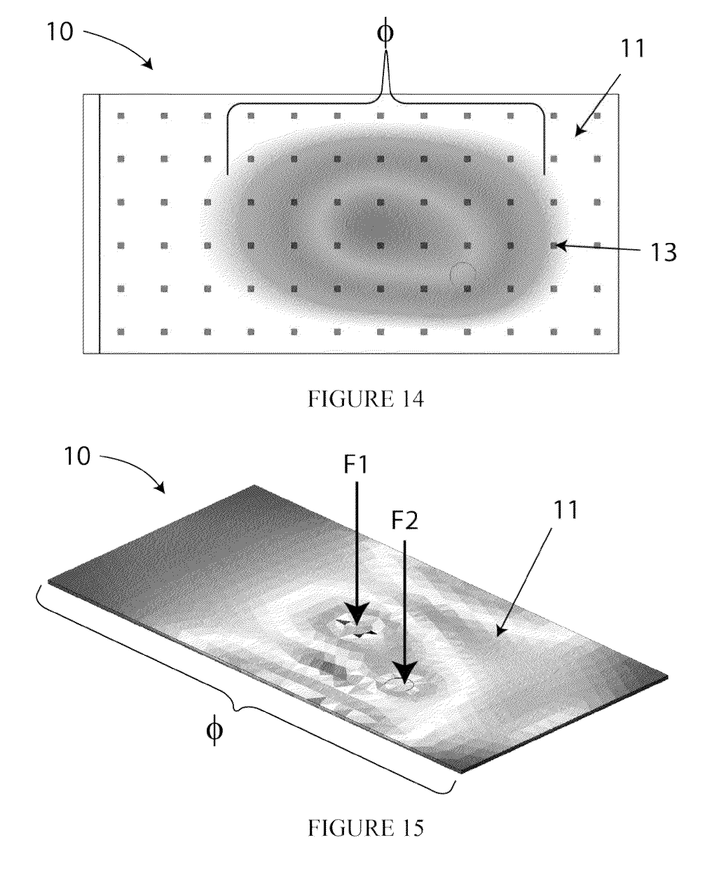

FIG. 14 is a top view of the sensor grid used to interpolate the location of force F.

FIG. 15 is an isometric of the force sensitive device with a force gradient from multiple touch points superimposed over the surface.

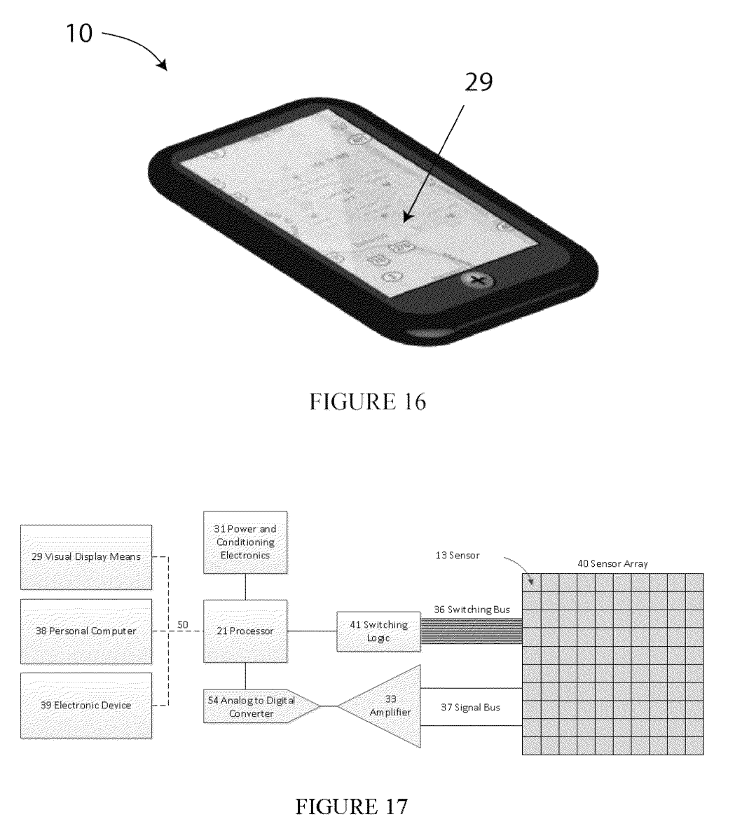

FIG. 16 is an isometric view of an exemplary interface device as described herein.

FIG. 17 is a schematic diagram depicting an exemplary arrangement of the processing circuitry of the interface devices as described herein.

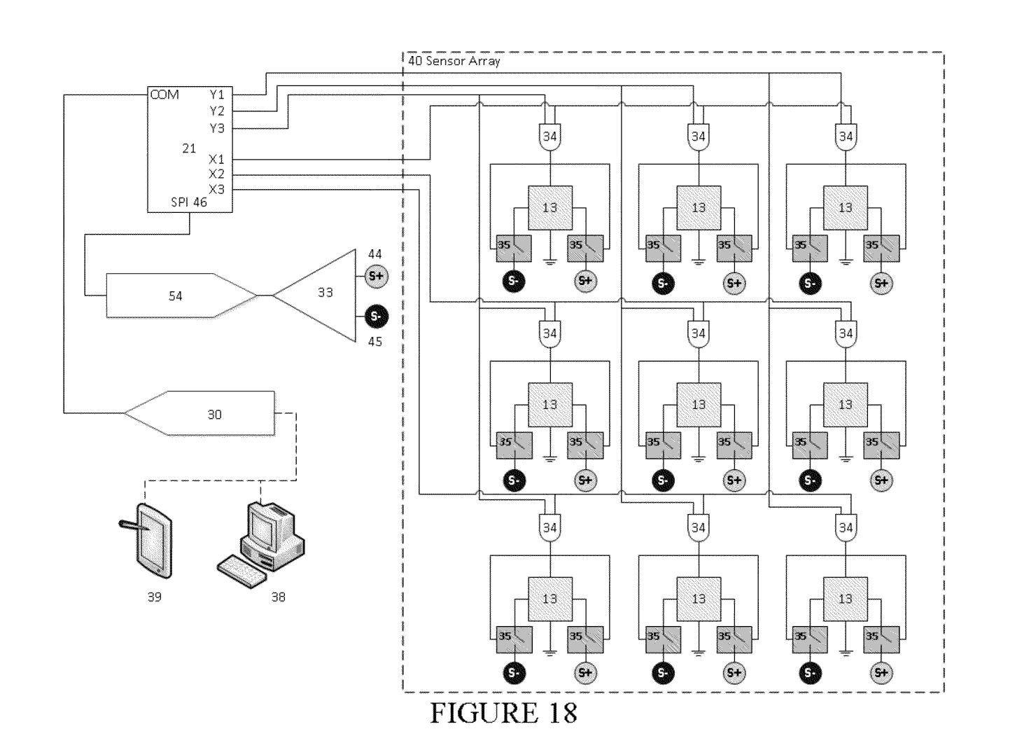

FIG. 18 is a schematic diagram depicting the electrical communications with the processing circuitry of the interface device as described herein.

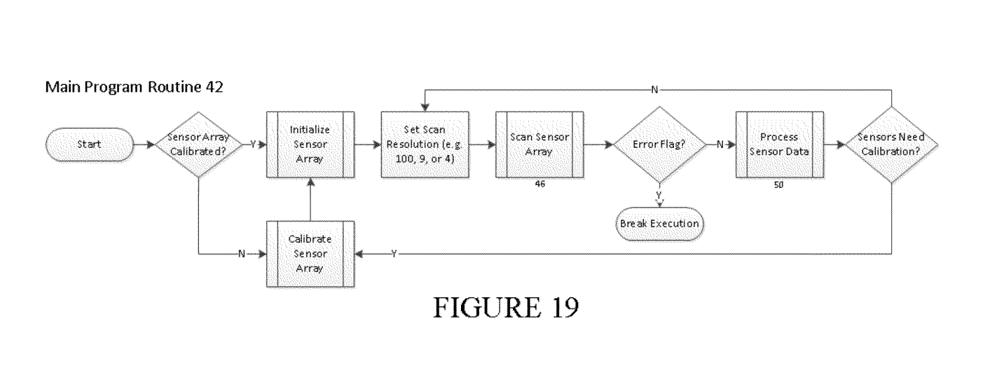

FIG. 19 is a diagram of the operating algorithm of the interface device as described herein.

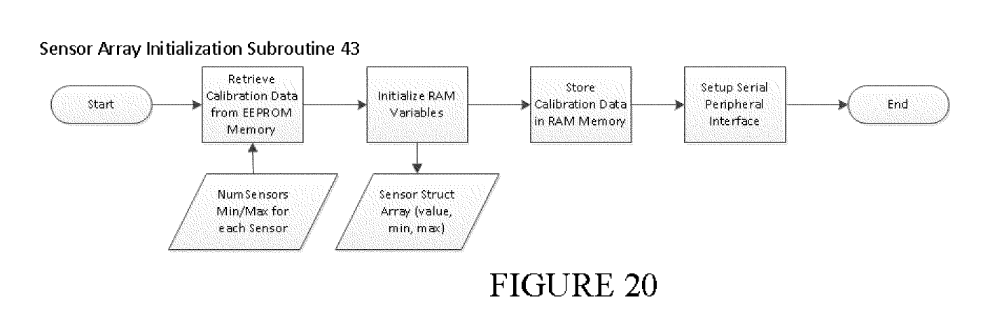

FIG. 20 is a diagram of the initialization subroutine of the interface device as described herein.

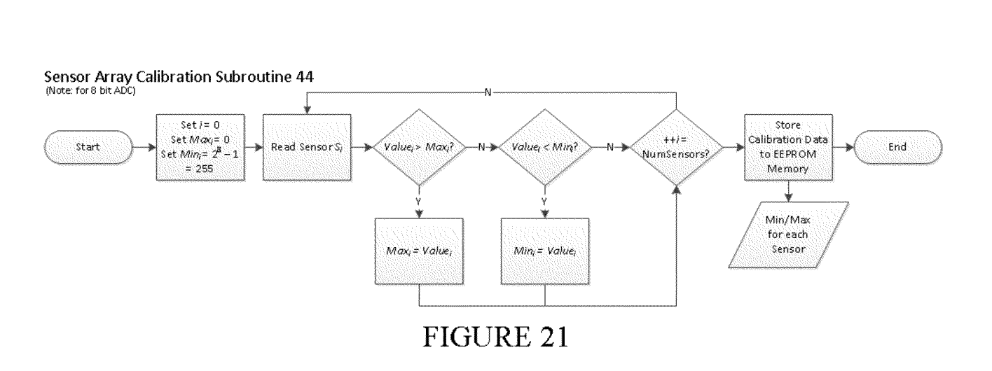

FIG. 21 is a diagram of the calibration subroutine of the interface device as described herein.

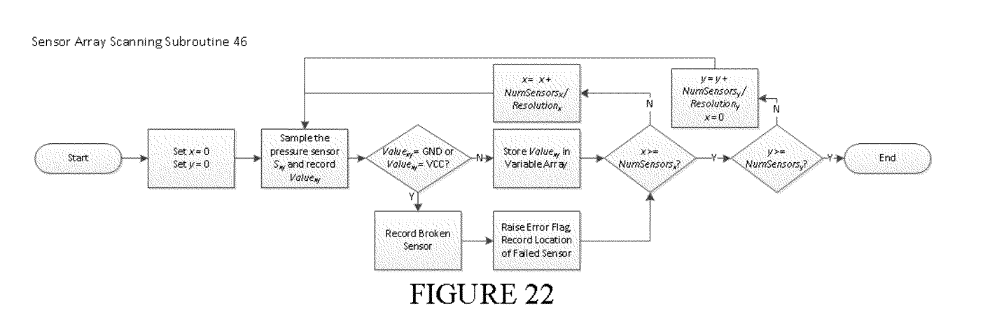

FIG. 22 is a diagram of the scanning subroutine of the interface device as described herein.

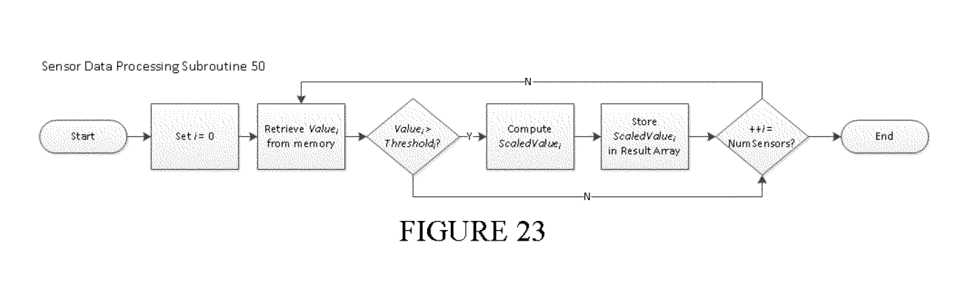

FIG. 23 is a diagram of the data processing subroutine of the interface device as described herein.

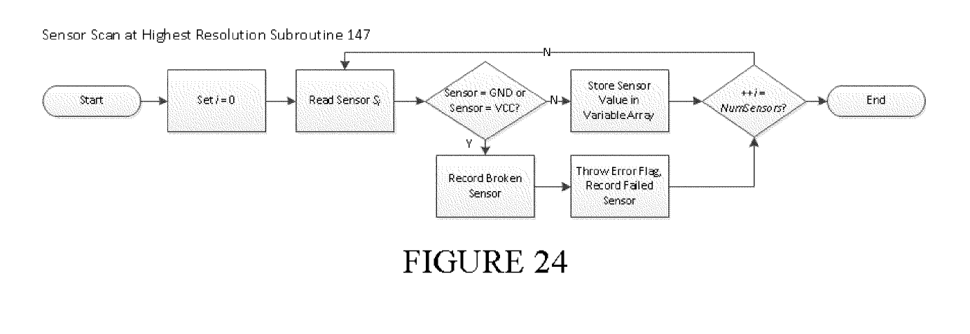

FIG. 24 is a diagram of the high resolution scanning subroutine of the interface device as described herein.

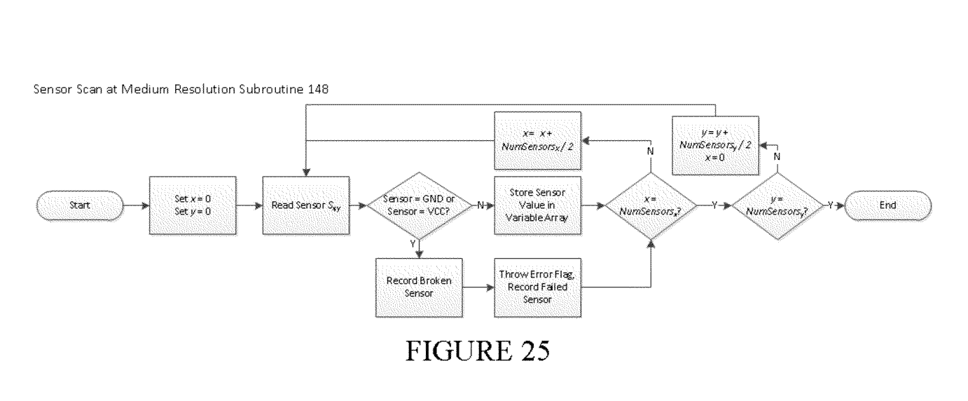

FIG. 25 is a diagram of the medium resolution scanning subroutine of the interface device as described herein.

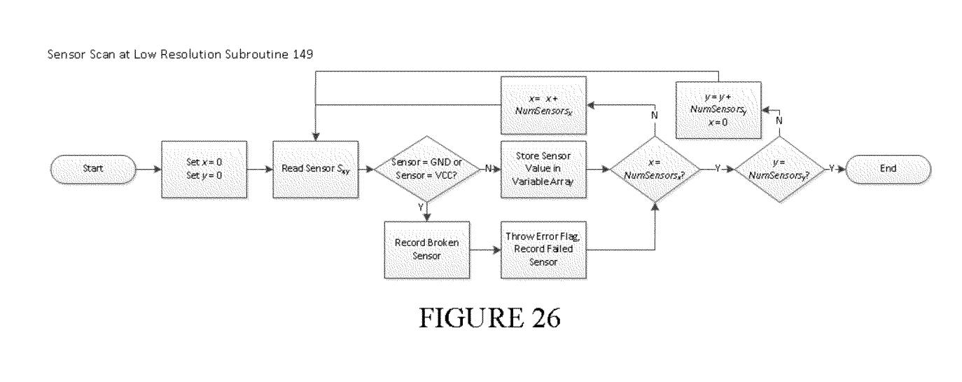

FIG. 26 is a diagram of the low resolution scanning subroutine of the interface device as described herein.

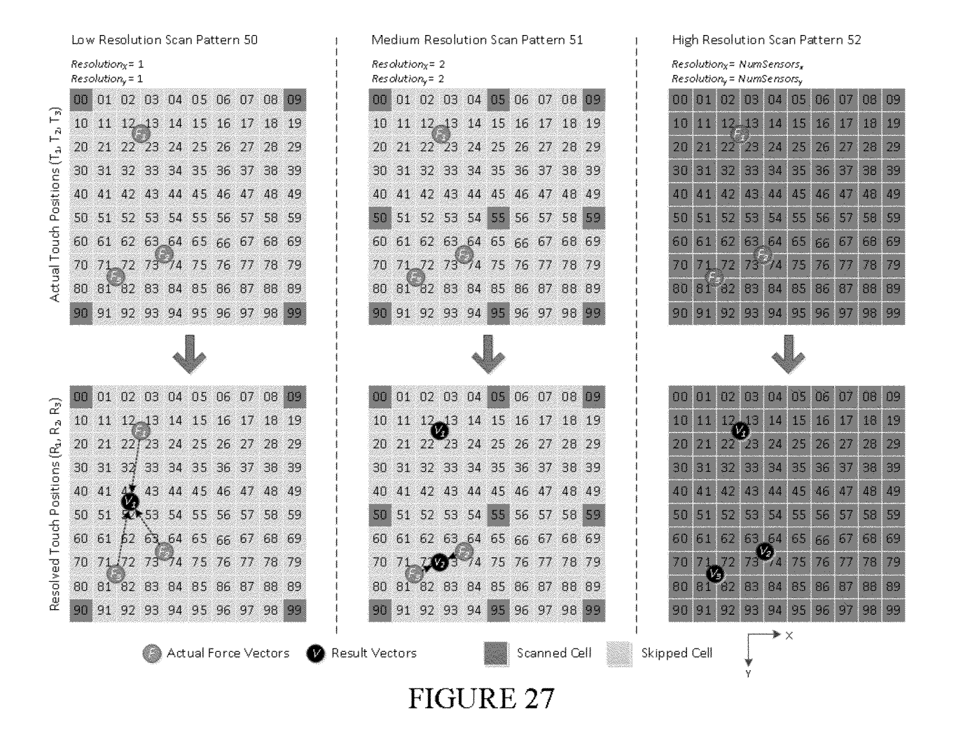

FIG. 27 is a diagram of the various scanning resolutions possible with the interface device as described herein.

### DETAILED DESCRIPTION

The present invention can be understood more readily by reference to the following detailed description, examples, drawings, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a force sensor” can include two or more such force sensors unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

As used herein, the term “contact” refers to any physical force exerted on at least a portion of a surface with a portion of the body of a user (such as a human or animal user), a stylus, a machine, or any other object or element capable of transmitting a force to the surface.

The word “or” as used herein means any one member of a particular list and also includes any combination of members of that list.

In one embodiment, the invention relates to an interface device for measuring a force applied to at least a portion thereof. In one aspect, as depicted in FIGS. 1-6, the interface device 10 comprises a contact body 16 formed of a flexible material and defining thereon the contact surface 11 for receiving the force F. In this aspect, the contact body 16 can further define an undersurface opposed from the contact surface 11. It is contemplated that the contact body 16 can have any shape, such as, for example and without limitation, a substantially square shape, a substantially rectangular shape as depicted in FIGS. 1-6, a substantially elliptical shape, and the like. As shown in FIG. 3, it is further contemplated that the contact body 16 can be affixed above a flexible display 12 such as, for example and without limitation, a liquid crystal display.

In an additional aspect, the interface device 10 can have affixed beneath the contact body 16 at least one sensor 13 in communication with the contact body 16 directly or through a flexible display 12 and configured to produce an electrical signal which is indicative of the force created by application of the force F upon the contact surface 11. Optionally, the at least one sensor 13 can comprise a plurality of sensors. It is contemplated that the signal can be an analog signal. It is further contemplated that the sensors 13 of the at least one sensor can be spaced such that the at least one sensor can detect the origin and magnitude of the force F applied to the contact surface 11. In one aspect, the at least one sensor 13 can be a piezoresistive force sensor, strain sensor, or pressure sensor and, in particular, can be a Wheatstone bridge piezoresistive force sensor, strain sensor, or pressure sensor configured to detect deformation within at least one doped silicon piezoresistive member in response to external forces. In another aspect, each sensor 13 of the at least one sensor can have a desired resolution, which corresponds to the smallest change in force, strain, or pressure that can be detected by each sensor.

In various aspects, the interface device 10 can have a rigid substrate 17. It is contemplated that the rigid substrate 17 can be made of a material such as, for example and without limitation, FR-4 glass epoxy.

In one exemplary aspect, and with reference to FIGS. 4 and 5, each sensor 13 of the at least one sensor can comprise a force sensor. In this aspect, the interface device 10 can comprise at least two spacers 18 that support the contact body 16 (and contact surface 11) above the rigid substrate 17. It is contemplated that the spacers can be made of, for example and without limitation, plastic.

In another exemplary aspect, and with reference to FIGS. 6 and 7, each sensor 13 of the at least one sensor can comprise a strain gauge. In this aspect, the interface device 10 can comprise at least two spacers 18 that support the contact body 16 (and contact surface 11) above the rigid substrate 17. It is contemplated that the spacers 18 can be made of, for example and without limitation, plastic, and be sized such that the at least one strain gauge 13 does not come into contact with the rigid substrate 17 upon application of the force F to the contact surface 11. As one having ordinary skill in the art will appreciate, the sizing of the spacers to prevent contact between the at least one strain gauge 13 and the rigid substrate 16 ensures that the at least one strain gauge is not damaged upon application of the force F.

In still another exemplary aspect, and with reference to FIGS. 8-13, the contact body 16 can be mounted onto a contact surface mount 25 made of, for example and not without limitation, ABS plastic, which is in turn mounted onto a rigid substrate 17 made of, for example and without limitation, FR-4 glass epoxy. In this aspect, the contact body 16 can define at least one fluid cell 24. It is contemplated that adhesives can be used to bond the contact body 16, the contact surface mount 25, and the rigid substrate 17 together, such that a seal is formed around each respective fluid cell 24 of the at least one fluid cell. In another aspect, upon engagement between the contact body 16, the contact surface mount 25, and the rigid substrate 17, each fluid cell 24 of the at least one fluid cell can contain a pressure sensor 13 in communication with the fluid cell 24 and configured to produce a pressure signal which is indicative of the pressure ρ created by application of the force F upon the contact surface 11.

In one aspect, the at least one fluid cell 24 can contain a fluid medium 28 which can be disposed within the at least one fluid cell. It is contemplated that the fluid medium 28 can comprise a gelatinous material, such as, for example and without limitation, silicone gel. It is contemplated that the fluid cells 24 of the at least one fluid cell can be sized such that the contact surface 11 does not engage with the at least one pressure sensor 13 upon application of the force F to the contact surface 11. As one having ordinary skill in the art will appreciate, the sizing of the at least one fluid cell 24 to prevent contact between the contact surface 11 and the at least one pressure sensor 13 ensures that the at least one pressure sensor is not damaged upon application of the force F.

Optionally, in some aspects, the rigid substrate 17 and/or the contact body 11 can have electrical routing 15 printed along one or more of their surfaces. For example, it is contemplated that the electrical routing 15 can optionally be printed on the undersurface of the flexible contact body 16. In other exemplary aspects, it is contemplated that the electrical routing 15 can optionally be printed on a bottom surface of the rigid substrate 17. In additional aspects, the electrical routing can be configured to transmit signals to a terminal block 14 at the edge of the rigid substrate 17 or contact surface 11. It is contemplated that the at least one sensor 13 can comprise a silicon die, and that it can be attached to the rigid substrate 17 or contact surface 11 with an adhesive such as, for example and without limitation, an epoxy. It is even further contemplated that the electrical terminals of the sensor 13 can be interfaced with the electrical routing 15 using, for example but without limitation, solder joints 22.

In this aspect, the terminal block 14 can be routed to processing circuitry 20 mounted on the rigid substrate 17 to allow for communication between the at least one sensor 13 on the contact surface 11 and the processing circuitry 20 on the rigid substrate 17. In an additional aspect, the processing circuitry 20 can be configured to receive the signal from the at least one sensor 13 to produce an output signal resulting from the processing of the signal. In another aspect, the processing circuitry 20 can comprise an instrumentation amplifier for amplifying the signal. In an additional aspect, the processing circuitry 20 can comprise a conventional analog/digital converter for digitally converting the signal of the at least one sensor 13. It is further contemplated that the signal can be a digital signal.

In another aspect, and with reference to FIGS. 4, 6, and 12, the processing circuitry 20 can comprise a processor 21. In this aspect, it is contemplated that the force F can be applied at an origin position relative to the contact surface 11. It is further contemplated that the processor 21 can be configured to identify the origin position of the force F to thereby produce one or more output signals, such as a single output signal or an array of output signals, corresponding to the signals measured by the at least one sensor 13. In this aspect, each output signal can comprise an integer indicative of the magnitude of the force F applied to the contact surface 11. For example, and without limitation, the integers comprising the output signal can range from 0 to 255, with 0 representing the lowest possible magnitude of the applied force and 255 representing the greatest possible magnitude of the applied force. In still a further aspect, the processor 21 can be configured to calculate two-dimensional coordinates corresponding to the origin position of the force F relative to the contact surface 11. In yet another aspect, it is contemplated that the output signals can be digital. In this aspect, the processing circuitry 20 can optionally comprise a digital/analog converter for converting the digital output signals into an analog signal. A diagram of exemplary processing circuitry is provided in FIG. 17.

Referring to FIGS. 4-8 and 12-14, in operation, when no force is applied to the contact surface 11, it is contemplated that the contact surface 11 will be at rest in the position P and, consequently, the at least one sensor 13 will sense a minimal constant force. When the force F is applied to the contact surface 11, it is contemplated that the contact surface 11 will deform and a force gradient φ centered at the origin of the force F will develop across the contact surface 11 as depicted in FIG. 14. The at least one sensor 13 can detect portions of this force gradient across the contact surface 11 and communicated through the contact surface 11 and the flexible display 12 and report the signal through the processing circuitry 20 to the processor 21. Using the force detected by each sensor 13 of the at least one sensor, the processor 21 can produce the output signal by calculating both the intensity of the force F applied to the contact surface 11 and the origin position of the force relative to the contact surface 11. It is contemplated that the processor 21 can be configured to produce the output signal as a set of vectors of force across the contact surface 11, as well as the two-dimensional coordinates corresponding to the origin position of the force F relative to the contact surface. For example, a vector of these results can be represented as V={f, x, y}, where V is the results vector, f is the magnitude of force observed by the at least one sensor 13, and x and y are the two-dimensional coordinates corresponding to the origin position of the force relative to the contact surface.

It is additionally contemplated that when multiple simultaneous forces F1 and F2 with unique origins and unique magnitudes are applied to the contact surface 11, as depicted in FIG. 15, a force gradient φ with multiple local maxima will develop across the contact surface. The at least one sensor 13 can detect this force gradient φ across the contact surface 11 and report the signal through the processing circuitry 20 to the processor 21. Using the force detected by each sensor 13 of the at least one force sensor, the processor 21 can produce the output signal by calculating both the intensity of each of the forces applied to the contact surface 11 and the origin position of each of the forces relative to the contact surface. It is contemplated that the processor 21 can be configured to produce output signals as vectors of maximum force across the contact surface 11, as well as two-dimensional coordinates corresponding to the origin position of each of the forces relative to the contact surface.

It is further contemplated that the processor 21 is programmed to contain a software algorithm that has previously stored two-dimensional coordinates (x, y) of each sensor 13 within the sensor array 40. The algorithm first scans each sensor 13 sequentially and stores the digitally converted analog sensor value within memory. The algorithm then creates a matrix M of three-dimensional sensor values (x, y, z). The algorithm assumes M defines a set of three-dimensional points (x, y, z) on a continuous response surface R. The algorithm assumes that the value z of the response surface R is known at each two-dimensional point (x, y). Further, the algorithm assumes that the derivatives

$$\frac{d R}{d x} , \frac{d R}{d y} , \\ and$$

$$\frac{d R}{d xy}$$

are known and continuous at each two-dimensional point (x, y). In this manner, the algorithm can calculate the response surface R, which represents an approximation of the actual force gradient φ. across the contact surface 11. The algorithm then finds the local maxima of the response surface R, and assumes each local maxima of the response surface R represents the origin and magnitude of a discrete force acting along the contact surface 11.

Referring now to FIG. 16, in an additional aspect, the interface device 10 can further comprise visual display means 29 which can be in electrical communication with the processing circuitry 20. In a further aspect, the visual display means 29 can be configured to display the output signal of the at least one sensor 13. It is contemplated that the visual display means 29 can be positioned external to the interface device 10. Alternatively, the visual display means 29 can be a flexible display attached to the contact surface 11. It is further contemplated that the visual display means 29 can comprise any conventional electrical display, such as, for example and without limitation, a single light emitting diode (LED), a one-dimensional array of LEDs, a two-dimensional array of LEDs, a liquid crystal display (LCD), or a conventional display monitor.

In an additional aspect, the interface device 10 can optionally comprise a memory. In this aspect, the memory can be in electrical communication with the processing circuitry 20, and configured to store at least one of the following: selected output signals of the at least one force sensor; device configuration data; device performance data; and two-dimensional coordinates of the at least one sensor 13. It is further contemplated that the device configuration data can comprise information regarding user-controlled performance specifications. It is still further contemplated that the device performance data stored on the memory can comprise information regarding the performance of the interface device 10. In another aspect, the memory can be configured to store timestamp values corresponding to the time at which an output signal was generated. In yet another aspect, the memory can be configured to store device identification information, such as, for example and without limitation, a serial number or a manufacturing batch number of the interface device 10.

In a further aspect, the processing circuitry 20 of the interface device 10 can comprise means for transmitting information to, and receiving information from, one or more external devices. In this aspect, the means for transmitting information 30 can be configured to transmit selected output signals of the at least one sensor 13 to the one or more external devices. In an additional aspect, and with reference to FIG. 18, the one or more external devices can comprise at least one of a personal computer and a conventional gaming console. In another aspect, the one or more external devices can comprise a measurement console configured to display output signals transmitted by the interface device 10. In yet another aspect, the one or more external devices can comprise any conventional electronic device, such as, for example and without limitation, a conventional personal digital assistant (PDA), a conventional cellular phone equipped with data receiving/transmission capabilities, and another conventional interface device, such as, for example and without limitation, a computer mouse.

It is contemplated that the means for transmitting information 30 can comprise at least one of a universal serial bus (USB) port, a wireless communications port, or other conventional data communications port. It is further contemplated that the means for transmitting information 30 can comprise a USB cable or other conventional data communications cable. In this aspect, the means for transmitting information 30 can optionally be detachable from the interface device 10. In another aspect, the means for transmitting information 30 can be configured to receive selected information from the one or more external devices to which the interface device 10 is connected. In this aspect, the selected information can comprise at least one of the following: selected output signals of the at least one sensor 13; device configuration data; and device performance data. It is contemplated that the device configuration data can comprise information regarding user-controlled performance specifications. It is still further contemplated that the device performance data stored on the memory can comprise information regarding the performance of the interface device 10. In one aspect, it is contemplated that the interface device 10 and the one or more external devices can function together as an electronic interface system.

It is contemplated that the processor 21 can be selectively configured to perform steps that control the operation of the interface device 10. In one aspect, the processor 21 can be configured to instruct each sensor 13 of the at least one sensor to substantially instantaneously generate a signal. In another aspect, the processor 21 can be configured to analyze the signals generated by the at least one sensor 13 and to perform a corresponding device operation. In one aspect, the device operation can comprise disregarding signals from the at least one sensor 13 if the signals are below a predetermined force value. In an additional aspect, the device operation can comprise displaying an output signal corresponding to a signal on the visual display means 29. In another aspect, the device operation can comprise transmitting an output signal corresponding to a signal of the at least one sensor 13 to one or more external devices using the means for transmitting information 30 disclosed herein. In yet another aspect, the device operation can comprise storing an output signal corresponding to a signal of the at least one signal in the memory of the interface device 10. In this aspect, the device operation can further comprise transmitting stored output signals from the memory to one or more external devices using the means for transmitting information 30 disclosed herein. In a further aspect, the device operation can comprise processing information received from an external device as described herein. In this aspect, the information received from the external device can comprise device configuration data.

In another aspect, the interface device 10 can comprise a power source 31 which can be in electrical communication with the processing circuitry 20. In one aspect, the power source 31 can comprise one or more conventional batteries. However, it is contemplated that any conventional power generation means can be used as the power source 31. In another aspect, the processing circuitry 20 can comprise means for sensing when the interface device 10 is connected to an external device. In this aspect, the processing circuitry 20 can be configured to electrically isolate the power source 31 when the interface device 10 is connected to an external device. It is contemplated that the interface device 10 can be powered by the external device during periods when the interface device is electrically connected to the external device. In a further aspect, the interface device 10 can comprise a conventional electronic power supply, including, for example and without limitation, an alternating current power supply. In this aspect, the electronic power supply can be configured for placement in electrical communication with the processing circuitry 20. In still a further aspect, the interface device 10 can comprise a conventional on/off switch in communication with the power source 31 configured to permit selective control of the supply of power to the interface device. It is contemplated that the on/off switch can be on an external portion of the support housing.

Referring now to FIG. 17, the interface device 10 can comprise a processor 21 in communication with switching logic 41 which communicates switching signals along a switching bus 36 to a sensor array 40 containing at least one sensor 13, such that the processor 21 can alternatively select sensors 13 within the sensor array. When selected, a sensor 13 within the sensor array 40 will produce an analog signal proportional to the force sensed by the sensor 13. The analog signal will be communicated through a signal bus 37 to an instrumentation amplifier 33 that will amplify the analog signal to an acceptable magnitude able to be interpreted by an analog to digital converter 54. The analog to digital converter 54 will produce a digital value proportional to the analog signal and communicate the digital value to the processor 21 for processing. The processor 21 stores the values of each sensor 13 within the sensor array 40 and interpolates the location and magnitude of the force gradient φ across the sensor array 40. The processor 21 then communicates this information to a visual display means 29, a personal computer 38, an electronic device 39, or any other data output means.

Referring now to FIG. 18, in operation, the interface device 10 can comprise a processor 21 in communication with a sensor array 40 containing at least one sensor 13, at least one AND gate 34, and at least two analog switches 35. In operation, the processor 21 uses a methodology to scan each sensor 13 in the sensor array 40. The methodology consists of the following steps: The processor 21 alternately selects between sensors 13 by energizing a pair of selecting circuits, for example Y1 and X1. The selecting circuits activate an AND gate 34, which in turn energizes the selected sensor 13 by closing the three analog switches 35 such that the selected sensor 13 is connected to power and a differential signal bus 37. The differential signal bus 37 is in communication with an instrumentation amplifier 33 which amplifies the differential analog signal produced by the selected sensor 13. The amplified analog signal is then communicated to an analog to digital converter 54 which converts the amplified analog signal to digital value able to be processed by the processor 21. The processor 21 then communicates this information to a visual display means 29, a personal computer 38, an electronic device 39, or any other data output means.

As depicted in FIGS. 19-21, it is contemplated that the interface device described herein will operate according to a methodology comprising the steps of initialization of the sensor array, calibration of the sensor array, and scanning the sensor array. When the interface device is first powered, the processor 21 reads data stored in memory to determine whether or not the sensor array 40 is calibrated. If the sensor array 40 is calibrated, the processor 21 then initializes the sensor array 40, sets the scanning resolution, and begins scanning the sensor array 40. If, during a scanning sequence, the interface device detects an error flag, the interface device will break execution. If not, the processor 21 will continue scanning the sensor array until all sensors have been scanned and then begin processing the resulting force gradient data from the at least one sensor 13.

Referring now to FIG. 20, to initialize the sensor array 40, the interface device performs the steps shown in the sensor array initialization subroutine 43. The processor 21 first retrieves sensor calibration data stored in long term memory, such as but not limited to EEPROM memory, and stores the data in fast access memory, such as but not limited to RAM memory. It is contemplated that the configuration data can be stored within an array of structured variables containing the fields Value, Min, and Max for each sensor 13 within the sensor array 40. The processor 21 then establishes communication with the sensor array 40 through a communication network, for example but without limitation a serial peripheral interface (SPI) 45.

Referring now to FIG. 21, to calibrate the sensor array 40, the interface device 10 performs the steps shown in the sensor array calibration subroutine 44. The processor 21 first sets a counter i to zero and for each of the structured variables outlined above, sets Maxᵢ to the lowest expected value, for example zero, and sets Minᵢ to the highest expected value, for example 255 in an 8-bit system. The processor 21 then samples the sensor 13 at the location i in the sensor array 40 and records the resulting value Valueᵢ corresponding to the amount of pressure that the sensor 13 at location i is sensing at that moment in time. The processor 21 then updates Minᵢ and Maxᵢ, which represent the minimum and maximum amounts of pressure that the sensor 13 at location i has sensed, respectively. To update Minᵢ and Maxᵢ, the processor 21 tests whether Valueᵢ is less than Minᵢ, and, if so, sets Minᵢ equal to Valueᵢ. Likewise, the processor 21 tests whether Valueᵢ is greater than Maxᵢ, and, if so, sets Maxᵢ equal to Valueᵢ. The processor 21 then increments the counter i and tests whether i has reached the number of sensors NumSensors representing the total number of sensors within the sensor array 40. When the sensor array calibration subroutine 44 is complete, the processor 21 will have computed the full range of each sensor 13, and will store the Min and Max for each sensor 13 in long term memory.

Referring now to FIG. 19, to scan the sensor array 40, the interface device 10 performs the sensor array scanning subroutine 46. The processor 21 first sets two counters x and y to zero. The processor then samples the sensor 13 at the location (x, y), where x is the position of the sensor 13 within the sensor array 40 along the x axis, and y is the position of the sensor within the sensor array 40 along the y axis, which is at some angle, for example 90 degrees, to the x axis. The processor 21 then records the resulting value Value_{xy} corresponding to the amount of pressure that the sensor 13 at location (x, y) is sensing at that moment in time. The processor 21 then increments x according to the equation:

$$x = x + \frac{{NumSensors}_{x}}{{Resolution}_{x}} ,$$

where NumSensorsₓ is the total number of sensors 13 along the x axis in the sensor array 40, and Resolutionₓ is a number between one and NumSensorsₓ corresponding to the resolution of the sensor array scanning subroutine 46. The processor 21 then tests whether x has reached or exceeded NumSensorsₓ. If so, the processor 21 sets x equal to zero and increments y according to the equation:

$$y = y + \frac{{NumSensors}_{y}}{{Resolution}_{y}} ,$$

where NumSensors_{y} is the total number of sensors 13 along the y axis in the sensor array 40, and Resolution_{y} is a number between one and NumSensors_{y} corresponding to the resolution of the sensor array scanning subroutine 46. The processor 21 then tests whether y has reached or exceeded NumSensors_{y}. If so, the processor 21 exits the sensor array scanning subroutine 46.

Referring now to FIG. 24-26, the interface device 10 is capable of resolving forces along the contact surface 11 with varying degrees of resolution by adjusting the scan pattern of the sensor array scanning subroutine 46, for example, and without limitation, a low resolution scan pattern 149, a medium resolution scan pattern 148, and a high resolution scan pattern 147. With a low resolution scan pattern 149, Resolutionₓ and Resolution_{y} are set to a low number, for example four. Then, the processor 21 only samples a small subset of sensors 13 within the sensor array 40. The interface device 10 is then only able to resolve force vectors, for example F₁, F₂, and F₃, to a smaller set of result vectors, for example R₁; however, the sensor array scanning subroutine 46 can be completed very quickly, resulting in lower power consumption by interface device 10. With a medium resolution scan pattern 148, Resolutionₓ and Resolution_{y} are set to a medium number, for example nine. Then, the processor 21 samples a larger subset of sensors 13 within the sensor array 40 than with a low resolution scan pattern 149, but still does not sample each sensor 13 within the sensor array 40. The interface device 10 is then able to resolve force vectors, for example F₁, F₂, and F₃ to a larger set of result vectors, for example R₁ and R₂, than is possible with a low resolution scan pattern 149. In this way, a medium resolution scan pattern 148 can strike a balance between resolution, computation time, and power consumption of the interface device 10. With a high resolution scan pattern 147, Resolutionₓ is set to NumSensorsₓ, the maximum number of sensors 13 within the sensor array 40 along the x axis, and Resolution_{y} is set to NumSensors_{y}, the maximum number of sensors 13 within the sensor array 40 along the y axis. In this way, each sensor 13 within the sensor array 40, is sampled, and the interface device 10 is able to resolve force vectors, for example F₁, F₂, and F₃ to the largest possible set of result vectors, for example R₁, R₂, and R₃; however, a high resolution scan pattern 147 will cause the interface device 10 to take the longest amount of time to complete the sensor array scanning subroutine 46 and consume the most amount of power.

Referring now to FIG. 23, to process sensor data, the interface device 10 performs the steps shown in the process sensor data processing subroutine 50. The processor 21 first sets a counter i to zero and retrieves the stored Valueᵢ corresponding to the value that the sensor 13 at location i sensed earlier. The processor 21 then tests whether Valueᵢ exceeds some threshold Threshold, and, if so, computes a scaled value ScaledValueᵢ which is mapped to some convenient range ScaledRange, for example 0 to 100, based on the range between Minᵢ and Maxᵢ, based on a scaling equation, for example:

$${ScaleValue}_{i} = \frac{( {Value}_{i} - {Min}_{i} ) * ( {Max}_{ScaledRange} - {Min}_{ScaledRange} )}{{Max}_{i} - {Min}_{i}} ,$$

where Min_{ScaledRange} is equal to the maximum of the scaled range, for example 0, and Max_{-ScaledRange} is equal to the maximum of the scaled range, for example 100. The processor 21 then stores ScaledValueᵢ in memory for later use. Next, the processor increments the counter i and tests whether i has reached or exceeded the number of sensors NumSensors in the sensor array 40. If so, the processor exits the sensor data processing subroutine 50, and if not, the processor iterates back through the subroutine.

In use, the interface device as described herein permits electrical communication with one or more external devices through various methods. In one aspect, a method for electrically communicating with one or more external devices comprises providing an interface device as described herein. In another aspect, the method for electrically communicating with one or more external devices comprises selectively applying a force at an origin position relative to the contact surface 11 of the body of the interface device. In this aspect, the force can be selectively applied at the origin position such that the operation of at least one application stored on a memory of the one or more external devices is adjusted. For example, the at least one application can be configured to receive an output signal from the processing circuitry and to perform a corresponding action within each respective application. It is contemplated that the at least one application can comprise, for example and without limitation, a game application, a computer aided design (CAD) application, a computer art design application, and the like.

### EXAMPLES

The interface devices and systems disclosed herein can be used in a variety of interactive applications. For example, the interface device can be used as a touch surface for mobile phones or tablets. In this example, the surface can be mounted beneath the LCD screen, allowing single- or multi-touch inputs to be detected, as well as the force of those inputs. A user can apply a force to the contact surface 11 at a desired magnitude so as to control the magnitude of an action in the device operating system, such as, for example and without limitation, the speed at which text scrolls when a scroll button is pressed.

In another example, the interface device can be placed in electrical communication with a personal computer or gaming console. In this example, the interface device can cooperate with a keyboard or other accessory to function as a game controller. The keyboard or other accessory item can be used to control directional movement during the course of the game. A user can concurrently apply a force to the contact surface 11 at a desired magnitude so as to control the magnitude of an action required by the game, such as, for example and without limitation, the velocity of a projectile.

In other gaming examples, the interface device can be used to control both two-dimensional movement during the course of a game and the magnitude of an action required by the game. For example, a user can move his or her finger(s) across the contact surface 11 to control the movement of a game character or item, and the user can apply a force to the contact surface 11 so as to control the magnitude of an action to be completed by the game character or item during the course of the game, such as, for example and without limitation, accelerating, stopping, swinging, throwing, and the like.

In a further example, the interface device can be used as a trackpad or mouse for a laptop or desktop computer. In this example, control of the mouse pointer can be derived from the users X and Y motion on the contact surface, and contextual force input can be used to add functionality such as dragging, zooming, or highlighting.

In another example, the interface device can be used as a means of control for a vehicle. In this example, a user can apply force to a contact surface displaying contextual menus to control vehicle cruise speed, entertainment system volume, track, or channel, or air conditioning settings. Force sensitive data can be used in this example to modify the rate at which the respective vehicle conditions change.

In a further example, the interface device can be used to interact with a CAD application. In this example, the interface can be placed in electrical communication with a personal computer running the CAD application. When the CAD application is running, a user can move his or her finger(s) across the contact surface 11 to control movement of a cursor on a visual display means in communication with the personal computer. The user can also apply a selected force to the contact surface 11 to control the degree to which a selected modeling tool is virtually applied to a CAD model within the CAD application.

In still a further example, the interface device can be used to interact with a computer art design application. In this example, the interface can be placed in electrical communication with a personal computer running the computer art design application. When the computer art design application is running, a user can move his or her finger(s) across the contact surface 11 to control movement of a cursor on a visual display means in communication with the personal computer. The user can also apply a selected force to the contact surface 11 to control the magnitude of a virtual effect that is applied to a computerized work, such as, for example and without limitation, the size of a paintbrush or the opacity of a color.

In another example, the interface device can be used as a means of control for a consumer electronic device. Such a device could include speaker docks, alarm clocks, DVD players, and home security systems. In this example, the interface can perform the function of one or more buttons, as well as add force sensitive functionality to various methods of device control, such as rate of volume increase/decrease, rate of time change, or rate of fast forward/rewind.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the invention description.

What is claimed is:

1. A force-sensitive interface device comprising:
a flexible contact body defining a contact surface, the contact surface configured to simultaneously receive a plurality of external forces;
a plurality of sensors operatively associated with the flexible contact body, each sensor of the plurality of sensors configured to sense localized forces applied to the contact surface of the flexible contact body and configured to produce a force signal indicative of the external forces sensed by the sensor; and
a processor positioned in operative communication with the plurality of sensors, the processor being configured to receive the force signal produced by each respective sensor of the plurality of sensors and to convert the force signals received from the plurality of sensors into one or more output signals indicative of the intensity and origin position of each respective force of the plurality of external forces.

2. The force-sensitive interface device of claim 1, wherein the processor is configured for selective communication with each respective sensor of the plurality of sensors, and wherein, upon initiation of communication between the processor and each respective sensor of the plurality of sensors, the sensor is configured to transmit the force signal to the processor.

3. The force-sensitive interface device of claim 2, wherein the flexible contact body defines an undersurface opposed from the contact surface, the force-sensitive interface device further comprising:
electrical routing printed on the undersurface of the flexible contact body, wherein the plurality of sensors are positioned in operative communication with the electrical routing; and
processing circuitry positioned in operative communication with the processor and the plurality of sensors.

4. The force-sensitive interface device of claim 3, wherein the processing circuitry comprises:
an analog-to-digital converter positioned in operative communication with the processor;
a signal bus coupled between and in electrical communication with the analog-to-digital converter and the electrical routing, the signal bus configured to transmit the force signals produced by the plurality of sensors to the analog-to-digital converter; and
a switching bus operatively coupled between and in electrical communication with the processor and the electrical routing, the switching bus configured to selectively initiate communication between the processor and each respective sensor of the plurality of sensors.

5. The force-sensitive interface device of claim 1, wherein the flexible contact body defines an undersurface opposed from the contact surface, the force-sensitive interface device further comprising:
a rigid substrate; and
a plurality of spacers positioned between and coupled to the rigid substrate and the undersurface of the flexible contact body,
wherein the plurality of spacers cooperate with the flexible contact body and the rigid substrate to define an interior chamber within the force-sensitive interface device.

6. The force-sensitive interface device of claim 5, further comprising a display fixedly attached to the flexible contact body such that the display is positioned over at least a portion of the contact surface of the flexible contact body.

7. The force-sensitive interface device of claim 5, wherein the plurality of sensors comprise a plurality of strain gauges.

8. The force-sensitive interface device of claim 7, wherein the plurality of strain gauges are operatively secured to the undersurface of the flexible contact body such that the plurality of strain gauges are positioned within the interior chamber and spaced from the rigid substrate.

9. The force-sensitive interface device of claim 8, wherein, upon application of the plurality of external forces from the user, the plurality of spacers are configured to prevent the plurality of strain gauges from contacting the rigid substrate.

10. The force-sensitive interface device of claim 7, further comprising:
electrical routing printed on the undersurface of the flexible contact body, wherein the plurality of strain gauges are positioned in operative communication with the electrical routing; and
processing circuitry positioned in operative communication with the processor and the plurality of strain gauges.

11. The force-sensitive interface device of claim 10, wherein the processing circuitry further comprises:
a first terminal block operatively coupled to the electrical routing on the undersurface of the flexible contact body; and
a second terminal block operatively coupled to the rigid substrate,
wherein the first terminal block is configured for operative communication with the second terminal block, and wherein the second terminal block is configured for further operative communication with the processor.

12. The force-sensitive interface device of claim 10, wherein the processor is configured for selective communication with each respective strain gauge of the plurality of strain gauges, and wherein, upon initiation of communication between the processor and each respective strain gauge of the plurality of strain gauges, the strain gauge is configured to transmit the force signal to the processor.

13. The force-sensitive interface device of claim 5, wherein the plurality of sensors comprise a plurality of piezoelectric force sensors.

14. The force-sensitive interface device of claim 13, wherein the plurality of piezoelectric force sensors are secured to and positioned between the undersurface of the flexible contact body and the rigid substrate.

15. The force-sensitive interface device of claim 14, wherein the processor is configured for selective communication with each respective piezoelectric force sensor of the plurality of piezoelectric force sensors, and wherein, upon initiation of communication between the processor and each respective piezoelectric force sensor of the plurality of piezoelectric force sensors, the piezoelectric force sensor is configured to transmit the force signal to the processor.

16. The force-sensitive interface device of claim 1, further comprising:
a rigid substrate having a top surface and an opposed bottom surface; and
a mount positioned between and operatively coupled to the rigid substrate and the flexible contact body,
wherein the flexible contact body defines a plurality of fluid cells, and
wherein the plurality of sensors are fixedly attached to and extending therefrom the top surface of the rigid substrate.

17. The force-sensitive interface device of claim 16, wherein the contact surface of the flexible contact body cooperates with the rigid substrate and the mount to form a seal around each respective fluid cell of the plurality of fluid cells, each fluid cell containing a fluid medium, and wherein each respective force sensor of the plurality of force sensors is aligned with a corresponding fluid cell of the plurality of fluid cells such that a force sensor is positioned within each fluid cell.

18. The force-sensitive interface device of claim 17, wherein the contact surface is spaced from the plurality of sensors, and wherein, upon application of the plurality of forces, the mount is configured to prevent the contact surface from contacting the plurality of sensors.

19. The force-sensitive interface device of claim 18, further comprising:
electrical routing printed on the bottom surface of the rigid substrate, wherein the plurality of sensors are positioned in operative communication with the electrical routing; and
processing circuitry positioned in operative communication with the processor and the plurality of sensors.

20. The force-sensitive device of claim 17, wherein the processor is configured for selective communication with each respective sensor of the plurality of sensors, and wherein, upon initiation of communication between the processor and each respective sensor of the plurality of sensors, the sensor is configured to transmit the force signal to the processor.

21. The force-sensitive device of claim 17, wherein the plurality of sensors comprise a plurality of pressure sensors.

22. The force-sensitive device of claim 1, wherein the one or more output signals produced by the processor comprise:
a vector of maximum forces applied across the contact surface; and
two-dimensional coordinates corresponding to the origin position of each respective external force relative to the contact surface.

23. A method of determining the origin position and intensity of a plurality of external forces, comprising:
simultaneously receiving the plurality of external forces on a contact surface of a flexible contact body, wherein a plurality of sensors are operatively associated with the flexible contact body;
sensing, through each sensor of the plurality of sensors, localized forces applied to the contact surface of the flexible contact body;
producing, through each sensor of the plurality of sensors, a force signal indicative of the external forces sensed by the force sensor; and
receiving, by a processor positioned in operative communication with the plurality of sensors, the force signal produced by each respective sensor of the plurality of sensors; and
converting, by the processor, the force signals received from the plurality of sensors into one or more output signals indicative of the intensity and origin position of each respective force of the plurality of external forces received on the contact surface.

24. The method of claim 23, further comprising selectively initiating communication between the processor and at least one selected sensor of the plurality of sensors, wherein, upon initiation of communication between the processor and each respective selected sensor of the at least one selected sensor, the selected sensor is configured to transmit the force signal to the processor.
